(19) United States
(12) Patent Application Publication
(10) Pub. No.: US 2025/0042139 A1
(43) Pub. Date: Feb. 6, 2025

(54) LAMINATE BARRIER WITH CERAMIC OR AEROGEL LAYER DEFINING VOIDS CONTAINING ENDOTHERMIC MATERIAL

(71) Applicants: Dow Silicones Corporation, Midland, MI (US); Dow Global Technologies LLC, Midland, MI (US)

(72) Inventors: Chi-Hao Chang, Midland, MI (US); Bizhong Zhu, Midland, MI (US); Thomas J. Parsons, Midland, MI (US); Kaila Mattson, Midland, MI (US); Craig Gross, Midland, MI (US); Joseph Sootsman, Saginaw, MI (US)

(21) Appl. No.: 18/715,136

(22) PCT Filed: Nov. 4, 2022
(86) PCT No.: PCT/US2022/048918

§ 371 Date: May 31, 2024

Related U.S. Application Data
(60) Provisional application No. 63/290,282, filed on Dec. 16, 2021.

(51) Int. Cl. B32B 27/06; B32B 5/02; B32B 5/18; B32B 7/12; B32B 27/12; B32B 27/18; B32B 27/28; H01M 10/658; H01M 50/293

(52) U.S. Cl. CPC B32B 27/065; B32B 5/02; B32B 5/18; B32B 7/12; B32B 27/12; B32B 27/18; B32B 27/283; H01M 10/658; H01M 50/293; B32B 2262/105; B32B 2266/126; B32B 2307/304; B32B 2307/3065; B32B 2307/54; B32B 2307/7376; B32B 2457/10

(57) ABSTRACT

An article contains a multilayer laminate having (a) a first surface layer with opposing primary surfaces, the first surface layer comprising a crosslinked polysiloxane matrix with flame retardant additive dispersed therein; (b) a central layer with opposing primary surfaces with one primary surface adhered to a primary surface of the first surface layer and wherein the central layer is selected from ceramic fiber sheet and aerogel sheet defining one or more than one void; (c) a second surface layer with opposing primary surface with one primary surface adhered to a primary surface of the central layer opposite the primary surface adhered to the first surface layer, the second surface layer having a composition as described for the first surface layer though the first and second surface layers do not have to have the same composition; wherein the article comprises endothermic agents occupying the voids defined by the central layer.

### FIELD OF THE INVENTION

The present invention relates to a laminated article comprising a central layer of ceramic or aerogel material that defines voids containing endothermic material. The article is useful as a barrier material for battery packs of electric vehicles.

### INTRODUCTION

Electric vehicle (EV) technology is becoming increasingly popular. EV technology utilizes a battery pack to store energy and power a vehicle. Energy demands of a vehicle are high, particularly with increasing desires and demands for EVs that can travel longer distances on each charge. Uncontrolled release of the energy of a battery pack for an EV can be catastrophic due to tremendous heat release. Therefore, it is desirable to design battery packs with protections against uncontrolled release of energy from the battery pack.

Battery packs for EVs typically comprise multiple battery cells that are electrically linked together and assembled to form a battery pack directly, or to form a module and then multiple modules are stacked to form a battery pack. An EV can contain up to thousands of battery cells. Failure in a single cell can release enough energy to heat up neighboring cells, resulting in failure of those neighboring cells with release of more energy which leads to thermal runaway and thermal propagation. Therefore, it is desirable to identify barrier materials that can reside between cells and modules of a battery pack and that can insulate neighboring cells from the thermal energy release if a cell fails.

Prefabricated ceramic sheets, such as ceramic fiber sheets, are commonly used as thermal insulation layers between cells in battery packs for EVs. However, ceramic sheets alone or even laminated ceramic sheets are frequently inadequate to block thermal propagation and thermal runaway in a battery pack. Aerogel blankets can have better thermal insulation properties than prefabricated ceramic sheets, but their performance can still be inadequate by themselves. Therefore, it is desirable to identify an article that offers flame retardancy and greater thermal insulating properties than just ceramic sheet or just aerogel sheet.

### BRIEF SUMMARY OF THE INVENTION

The present invention provides an article that offers flame retardancy and greater thermal insulating properties than just a ceramic sheet or an aerogel sheet. The present invention is a result of discovering a multilayer laminate that comprises a ceramic layer or aerogel layer between two silicone layers where the ceramic or aerogel layer defines voids filled with endothermic agents. The silicone layers comprise flame retardant additives and offer thermal insulating properties and flame retardant barrier properties. The ceramic layer offers further flame retardant properties, while the voids filled with endothermic agents provide even greater thermal barrier properties by absorbing heat and, at least in some instances, releasing the heat in heated gasses to remove the heat from the area of a battery pack that is experiencing exothermic failure. This combination of elements surprisingly works together to provide particularly desirable thermal and fire barrier properties to the laminate structure, which can reside between cells of a battery pack.

The multilayer laminate can achieve a “Time to 180° C. per millimeter thickness” result of 20 seconds or more, even 25 seconds or more, even 40 seconds or more in the Thermal Insulating Property test described herein. At the same time, the multilayer laminate is flame resistant as demonstrated by lack of flames when compressed directly against a hot plate at a temperature of at least 650° C. in the Flame Resistance test method described herein. The multilayer laminate can achieve these properties even with a thickness of 10 millimeters (mm) or less, even 5 mm or less. Therefore, the multilayer laminate achieves desired properties to serve as barrier materials for use in EV battery packs.

In a first aspect, the present invention is an article comprising a multilayer laminate that comprises: (a) a first surface layer with opposing primary surfaces, the first surface layer comprising a crosslinked polysiloxane matrix with flame retardant additive dispersed therein at a concentration in a range of 5-95 weight-percent based on first surface layer weight: (b) a central layer with opposing primary surfaces with one primary surface adhered to a primary surface of the first surface layer and wherein the central layer is selected from ceramic fiber sheet and aerogel sheet; (c) a second surface layer with opposing primary surface with one primary surface adhered to a primary surface of the central layer opposite the primary surface adhered to the first surface layer, the second surface layer having a composition as described for the first surface layer though the first and second surface layers do not have to have the same composition; wherein the central layer defines one or more than one void such that the total volume of voids defined in the central layer is in a range of 5 to 95 volume-percent of volume defined by the central layer and wherein the article comprises endothermic agents that occupy the voids defined by the central layer. The article can further comprise battery cells that are electrically connected with one another with the multilayer laminate residing between the battery cells.

The laminate of the present invention is useful as a thermal and fire barrier material in battery packs such as those in EVs.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods; END refers to European Norm; DIN refers to Deutsches Institut für Normung; ISO refers to International Organization for Standards; and UL refers to Underwriters Laboratory.

Products identified by their tradename refer to the compositions available under those tradenames on the priority date of this document.

“Multiple” means two or more. “And/or” means “and, or as an alternative”. All ranges include endpoints unless otherwise indicated.

“Sheet” refers to an article having opposing primary surfaces separated by a thickness that is less than 1/10^{th} the size of the length or width defining the primary surfaces.

Width, length, and thickness are mutually perpendicular dimensions of an object.

“Primary surface” refers to a surface of an object that has the largest planar surface area as well as a surface opposing that surface. A planar surface area refers to the surface area as projected onto a plane to eliminate contributions to surface area from contours on the surface. Opposing primary surfaces are separated by the thickness dimension of the object.

The present invention is an article that comprises a multilayer laminate. The article can consist of the multilayer laminate or can comprise components in addition to the multilayer laminate. For instance, the article can comprise battery cells with the multilayer laminate residing between the battery cells.

The multilayer laminate comprises a first surface layer, a central layer and a second surface layer in that order relative to one another. A “laminate” means that the layers reside over one another and are adhered to one another. Typically, the primary surfaces of the adhered layers are adhered to one another. “Adhered to” means attached either directly with direct contact between the adhered layers or attached through an adhesive with the adhesive residing between the adhered layers. The adhesive can be a layer that covers the entirety of the adhered surfaces or can reside over only a portion of the adhered surfaces.

The first surface layer and the second surface layer can be the same or different in composition and/or dimensions but are each selected from materials having similar compositional and dimensional descriptions. The first and second surface layers each have opposing primary surfaces and comprise a crosslinked polysiloxane matrix and a flame retardant.

The crosslinked polysiloxane matrix desirably has a 10-percent strain modulus of at least 100 Pascals (Pa), and preferably has a 10-percent strain modulus of 200 Pa or more, 300 Pa or more, 400 Pa or more, 500 Pa or more, 600 Pa or more, 700 Pa or more, 800 Pa or more, 850 Pa or more, 900 Pa or more, 1000 Pa or more, 2000 Pa or more, 4000 Pa or more 6000 Pa or more, 8000 Pa or more, 10 kiloPascals (kPa) or more, 100 kPa or more, 500 kPa or more, 800 kPa or more, even 870 kPa or more. There is no technical upper limit to the 10-percent strain modulus value for the crosslinked polysiloxane matrix but it often is, at the same time as having the afore-mentioned lower limits, has an upper limit for its 10-percent strain modulus of one GigaPascal (GPa) or less, 0.5 GPa or less, 100 MegaPascal (MPa) or less, 50 MPa or less, 25 MPa or less, 15 MPa or less, 100 MPa or less, 5 MPa or less, one MPa or less, or even 900 kPa or less. 10-percent strain modulus is the tensile stress of the material at 10-percent elongation as determined according to ASTM D412. Desirably, the crosslinked polysiloxane matrix is flexible.

The crosslinked polysiloxane matrix can be a crosslinked liquid polysiloxane elastomer or a crosslinked polysiloxane gum. A “crosslinked liquid polysiloxane elastomer” is a polysiloxane elastomer made by crosslinking liquid polysiloxanes. Crosslinked liquid polysiloxane elastomers and crosslinked gums are well known and can be made by any known process. Desirably, the crosslinked liquid polysiloxane elastomer comprises 50 mole-percent (mol %) or more, 60 mol % or more, 70 mol % or more, 80 mol % or more, 90 mol % or more and can contain 95 mol % or more polysiloxane units selected from RSiO_{3/2} and R₂SiO_{2/2} units based on total siloxane units. Polysiloxane units are R₃SiO_{1/2} (“M”-type units), R₂SiO_{2/2} (“D”-type units), RSiO_{3/2} (“T”-type units) and SiO_{4/2} (“Q”-type units), where each R is independently selected from hydrocarbyl and substituted hydrocarbyl groups and the oxygen atoms listed in the units refer to oxygens bonded to silicon atoms of two different siloxane units with the subscript on the oxygen referring to the number of shared oxygens in the numerator and designates the oxygen atom is shared with another siloxane unit by dividing the numerator by 2. Examples of suitable polysiloxane elastomers for use as the polysiloxane matrix include, for example, a crosslinked dimethylvinyl terminated dimethyl, methyl vinyl siloxane gum and/or crosslinked dimethlyvinyl terminated dimethyl siloxane gum, each having a Williams plasticity (determine Williams plasticity according to ASTM D926) of 154-155 millimeters/100 millimeters.

Curing of a liquid siloxane and/or polysiloxane gum can be accomplished by for example, free radical, hydrosilylation and/or condensation reactions. Free radical polymerization can be catalyzed by, for example, peroxides. Hydrosilylation curable silicone compositions comprise one or more vinyl containing siloxane polymer and one or more silicon-hydride functional siloxane. At least one of the vinyl containing siloxane polymer and silicon-hydride functional siloxane contain two or more of the specified functionality so as to act as a crosslinker. Hydrosilylation catalysts such as platinum compounds are typically present to facilitate the hydrosilylation reaction. Condensation reaction curable silicone compositions comprise siloxanes bearing condensation curable functionalities such as any one or more selected from hydroxyl and hydrolysable functional groups such as alkoxy, carboxy, amido, epoxy, amino, oximo, and amioxy groups. Condensation reaction curable silicone compositions typically further comprise crosslinkers such as silanes bearing hydrolysable groups, water scavengers such as vinyl trimethoxysilane and methyltrimethoxysilane, and curing catalysts such as titanium and tin compounds can be formulated to tune in curing behavior, shelf life and other properties after cure. The condensation reaction curable silicone composition can be cured at room temperature or at an elevated temperature, with or without artificially added moisture in addition to what is available from the atmosphere as it cures.

Desirably, the polysiloxane matrix is a continuous non-porous sheet.

The first and second surface layers further comprise fire retarding additives dispersed within the crosslinked polysiloxane matrix. Suitable fire retarding additives include any one or any combination of more than one selected from a group consisting of metal hydroxides, mixed metal hydroxides, hydrated metal salts and combinations thereof. Desirably, the fire retarding additives are any one or any combination or more than one additive in a group consisting of aluminum trihydrate and magnesium hydroxide, calcium hydroxide, magnesium carbonate hydroxide, aluminum carbonate hydroxide, boehmite, hydrated magnesium sulfate, magnesium carbonate trihydrate, and magnesium carbonate hydroxide tetrahydrate. Optionally, the polysiloxane layer can further comprise metal carbonates and bicarbonates in combination with metal hydroxides, metal salts, mixed metal hydroxides and/or hydrated metal salts to further improve flame retardancy. Examples of metal carbonates and bicarbonates include magnesium carbonate, magnesium calcium carbonate (for example, that marketed as huntite) and sodium bicarbonate. The fire retarding additives can optionally be surface treated.

The fire retarding additives are present in each of the first and second surface layers at a concentration of 5 weight-percent (wt %) or more, 10 wt % or more, 15 wt % or more, 20 wt % or more, 25 wt % or more, 30 wt % or more, and can be present at a concentration of 35 wt % or more, 40 wt % or more, 45 wt % or more, 50 wt % or more, 55 wt % or more, 60 wt % or more, 65 wt % or more, 70 wt % or more, 75 wt % or more, even 80 wt % or more while at the same time are typically present at a concentration of 95 wt % or less, and can be present at a concentration of 90 wt % or less, 85 wt % or less, 80 wt % or less, 75 wt % or less, 70 wt % or less, 65 wt % or less, 60 wt % or less, 55 wt % or less, even 50 wt % or less, 45 wt % or less, 40 wt % or less, or 35 wt % or less with wt % fire retarding additive relative to weight of the surface layer they are in.

The first and/or second surface layer can comprise or be free of any one or any combination of more than one additional additive. “Additional additives” are additives included in addition to the fire retarding additives already mentioned above. For example, the polysiloxane layer can comprise any one or any combination of more than one additional additive selected from a group consisting of silica, calcium silicate, calcium metasilicate, fumed silica, precipitated silica, ground quartz, precipitated and ground calcium carbonate, calcium sulfate, magnesium sulfate, barium sulfate, zeolites, TiO₂, ZnO, magnesium oxide, iron oxides, boron oxide, wollastonite, perlite, vermiculite, mica, Kaolin, glass, glass bubbles, aerogel particles, diatomaceous earth, halloysite, magnetite, hematite; other flame retarding additives such as benzotriazole, ammonium polyphosphate, ammonium or aluminum alkyl phosphinate, melamine polyphosphate, organophosphate, halogenated organophosphate, other halogen containing fire retardants with or without antimony oxide, dihydrooxaphosphaphenanthrene, zinc stannate, zine hydroxostannate, platinum metal and platinum metal composition, colorants such as carbon black and pigments (for example, ultramarine blue pigment, and/or yellow 109), stabilizers such as cerium hydroxide; curing catalysts such as peroxides, organostannates or titanates, Pt; curing reaction accelerators or deccelerators such as amines, acetylenic alcohols, organic phosphines; rheology modifiers such as diluents and thickeners; and/or density reducing additives such as hollow glass or ceramic additives.

The combined concentration of fire retarding additives and additional additives in a surface layer is 95 wt % or less, and can be 90 wt % or less, 85 wt % or less, 80 wt % or less, 75 wt % or less, 70 wt % or less, 65 wt % or less, 60 wt % or less, 55 wt % or less, even 50 wt % or less, 45 wt % or less, 40 wt % or less, or 35 wt % or less based on weight of the surface layer provided the amount of fire retarding additives is within the ranges specified above for fire retarding additives.

Typically, each surface layer has a thickness of 0.1 millimeter (mm) or thicker, and typically is 0.2 mm or thicker, 0.3 mm or thicker, 0.4 mm or thicker, 0.5 mm or thicker, 0.6 mm or thicker, 0.7 mm or thicker, 0.8 mm or thicker, 0.9 mm or thicker, 1.0 mm or thicker, 1.2 mm or thicker, 1.2 mm or thicker, 1.4 mm or thicker, 1.6 mm or thicker, 1.8 mm or thicker, even 2.0 mm or thicker. There is no technical restriction on the upper limit as to how thick the polysiloxane layer can be. However, typically, in combination with any of the lower limits, the polysiloxane is 10 mm or thinner, 5.0 mm or thinner, 3.0 mm or thinner, 1.0 mm or thinner, 0.8 mm or thinner, 0.7 mm or thinner, 0.6 mm or thinner, and can be 0.5 mm or thinner, 0.4 mm or thinner, even 0.2 mm or thinner.

The central layer has opposing primary surfaces with one primary surface adhered to a primary surface of the first surface layer and the opposing primary surface adhered to a primary surface of the second surface layer. The central layer is selected from a group consisting of ceramic fiber sheet and aerogel sheet.

Ceramic fiber sheet is non-woven or woven sheet comprising a wide range of amorphous or crystalline mineral fibers such as alumino-silicate, metal oxides (e.g., alumina, silica, zirconia), non-oxide materials (for example, silicon carbides, silicon nitride, boron nitride). Suitable ceramic fiber sheets are commercially available in the name of CeraTex® Ceramic Fiber Paper, CeraTex® Ceramic Fiber Blanket, Fiberfrax® Ceramic Fiber Papers, Isofrax® 1260 C Paper. (CeraTex is a trademark of Mineral Seal Corporation. Fiberfrax and Isofrax are trademarks of Unifrax I LLC). Desirable characteristic of ceramic fiber sheet is flame retardant above 100° C., more preferably above 650° C.

Aerogel sheets are sheets made of aerogel material. In the broadest scope of the invention, the aerogel material can comprise or consist of any aerogel material such as silica aerogel, metal oxide aerogel, mixed metal oxide aerogel, organic or carbon aerogel, semiconducting metal aerogel, chalcogenide aerogel, metal aerogel, silane and siloxane modified aerogels, and reinforced forms of any of these aerogels. “Aerogel” includes what have been known as “xerogels”, which are porous structures that are typically formed by drying a wet gel resulting in more volume shrinkage than 10% for more conventionally known supercritically dried aerogels. The aerogel material can be a reinforced aerogel. Reinforced aerogels include aerogels with fiber reinforcing materials such as glass fiber and/or carbon fiber. Fiber reinforced aerogels can have a fiber mat, mesh or batting within an aerogel material. Such materials are commercially available and can be prepared by disposing an aerogel precursor sol into or around a fiber mat, mesh or batting and then converting the sol to an aerogel with the fiber mat, mesh or batting with the aerogel. Fiber reinforced silica aerogel is particularly desirable for use as an aerogel layer.

The central layer typically has an average thickness of 0.5 mm or thicker and can have a thickness of 1.0 mm or thicker, 1.5 mm or thicker, 2.0 mm or thicker, 2.5 mm or thicker, 3.0 mm or thicker, 4.0 mm or thicker, 5.0 mm or thicker, 10 mm or thicker, 20 mm or thicker, 30 mm or thicker, even 40 mm or thicker while at the same time generally has a thickness of 50 mm or less, and can have a thickness of 40 mm or less, 30 mm or less, 20 mm or less, 10 mm or less, 5.0 mm or less, 4 mm or less, or even 3.0 mm or less.

The central layer defines one or more than one void that can extend partially or all the way through the thickness of the central layer. Each void can have a volume of 5 volume-percent or more, even 10 vol % more, even 20 vol % or more of the total volume of the central layer. The total volume of void space defined by the central layer is 5 vol % or more, and can be 10 vol % or more, 15 vol % or more, 20 vol % or more, 25 vol % or more, 30 vol % or more, 35 vol % or more, 40 vol % or more, 45 vol % or more, 50 vol % or more, 55 vol % or more, 60 vol % or more, 65 vol % or more, 70 vol % or more, 75 vol % or more, 80 vol % or more, 85 vol % or more, even 90 vol % or more while at the same time is typically 95 vol % or less, and can be 90 vol % or less, 85 vol % or less, 80 vol % or less, 75 vol % or less, 70 vol % or less, 65 vol % or less, 60 vol % or less, 55 vol % or less, 50 vol % or less, 45 vol % or less, 40 vol % or less, 35 vol % or less, 30 vol % or less, or even 25 vol % or less of the total volume of the central layer.

The multilayer laminate further comprises endothermic agents that occupy the voids defined by the central layer. The endothermic agents are typically particulate in form and so many particulates of endothermic agents occupy a given void. Endothermic agents are materials that absorb heat as they decompose to produce carbon dioxide and/or water at a temperature in a range of 80° C. to 550° C. The endothermic agents can all be the same or they can be a combination of multiple different endothermic agents. Examples of endothermic agents that produce water as they absorb heat and decompose include metal hydroxides and hydrates of metal salts such as aluminum hydroxide, magnesium hydroxide, calcium hydroxide, calcium-magnesium hydroxide, hydrotalcite, boehmite, talc, calcium sulfate hydrate, magnesium hydrate, and zinc borate. Specific examples include hydrous magnesium sulfate mineral (for example, epsomite), aluminum trihydrate and magnesium hydroxide. Examples of endothermic agents that produce carbon dioxide as they absorb heat and decompose include magnesium carbonate, calcium carbonate, magnesium calcium carbonate, sodium bicarbonate, lithium carbonate, magnesium bicarbonate, and potassium bicarbonate. Examples of endothermic materials that release both water and carbon dioxide while absorbing heat and decomposing include hydrated magnesium carbonate mineral such as hydromagnesite. The endothermic agents can fully or partially occupy the void spaces defined in the central layer. Desirably, the void spaces and endothermic agents are located throughout the central layer rather than concentrated in a small portion of the central layer. The role of the endothermic agents is to mitigate thermal transfer through the multilayer laminate by absorbing heat and releasing water or carbon dioxide so it is optimal to distribute endothermic agents broadly throughout the central layer. In that regard, it is desirable for the central layer to define voids broadly distributed throughout the central layer with endothermic agents occupying those voids.

The endothermic agent occupies the void volume defined in the central layer and as such can occupy anywhere in a range of 5 to 95 vol % of the volume defined by the central layer. Desirably, endothermic agents occupies 40 vol % or more, preferably 45 vol % or more, 50 vol % or more, even 55 vol % or more, and at the same time typically 95 vol % or less, 90 vol % or less, 85 vol % or less, 80 vol % or less, 75 vol % or less, 70 vol % or less, 65 vol % or less, 60 vol % or less, or even 55 vol % or less, 50 vol % or less, or even 45 vol % or less of the volume defined by the central layer.

One example of a desirable void orientation in the central layer includes having one large void space defined by a perimeter of central layer material such that endothermic agent in the void space occupies most of the volume of the central layer space as a continuous. Another example of a desirably void orientation is to have multiple void spaces defined throughout the central layer and occupied by endothermic material so as to effectively provide a broad distribution of endothermic material across the central layer.

The endothermic agents are typically sealed within the voids they occupy by the central layer and first and second surface layers.

The multilayer laminate can be made by any means conceivable. For instance, a first surface layer can be adhered to a central layer and then endothermic agent placed into voids defined by the central layer and then a second surface layer can be adhered onto the central layer sandwiching the central layer and endothermic agents between the first and second surface layers.

One, both, or neither of the surface layers can be adhered directly to the central layer. To accomplish direct adhesion between a surface layer and the central layer the surface layer can be cured to form a crosslinked polysiloxane matrix while in contact with the central layer.

One, both or neither surface layer can be adhered to the central layer using an adhesive. Adhesive can reside between a surface layer and the central layer adhering the two layers together. The adhesive can completely cover the surfaces adhered to one another so as to form a film between the two layers. Alternatively, the adhesive can cover only a portion of the surfaces adhered to one another. The adhesive can be continuous such as in a film or a bead or can be discontinuous such as in a series of dots, disconnected beads or combination of beads and dots. The adhesive can be in any pattern that adheres a surface layer to a central layer.

The adhesive, if used, can be a silicone adhesive. The adhesive can be a one-part or a two-part adhesive. The adhesive desirably contains flame retardant additives. For example, the adhesive can be a silicone foam adhesive such as the one commercially available under the name DOWSIL™ 3-8235 Silicone Parts A and B from The Dow Chemical Company. DOWSIL is a trademark of The Dow Chemical Company. Desirably, the adhesive is suitable for high temperature applications.

The multilayer laminate is particularly useful as an insulator between cells of a battery module for electric vehicles. In that regard, the article of the present invention can further include multiple battery cells with the multilayer laminate residing between the battery cells. The article can be a battery module that can be in a vehicle, the battery module comprising a housing in which there are multiple battery cells with the multilayer laminate residing between the battery cells.

### EXAMPLES

Table 1 lists the materials for use in the following examples.

TABLE 1

| Component | Description | Source |
|---|---|---|
| G1 | Silicone gum that is dimethylvinyl- | Prepare according to teachings in |
| | terminated dimethyl, methylvinyl siloxane | WO2020131985 |
| | gum having a Williams plasticity of 155 | |
| | mm/100 mm and a vinyl content of 0.06 wt % | |
| B1 | A silicone base containing having a | Available under the name |
| | Williams plasticity of 150 mm/100 mm | XIAMETER ™ RBB 2600-35 from |
| | and a vinyl content of 0.05 wt %. | The Dow Chemical Company. |
| F1 | Silicone fluid that is triethoxyvinylsilane | Prepare according to teachings in |
| | | U.S. Pat. No. 6,348,437B1 |
| A1 | Pigmentable flame retardant additive that | Available under the name |
| | includes benzotriazole dispersed in | XIAMETER ™ RBM-9006 |
| | silicone. | Modifier from The Dow Chemical |
| | | Company. |
| P1 | Bis-(2,4-dichlorobenzoyl) peroxide, 50 | Available under the name |
| | wt % concentration in a hydroxy terminated | XIAMETER ™ RBM-9020 from |
| | dimethyl methylvinyl siloxane oil. | The Dow Chemical Company. |
| Blue Pigment | Ultramarine blue pigment as | Available from Ferro Corporation |
| | masterbatch in siloxane | |
| Magnesium | Magnesium ferrite pigment as | Available from Ferro Corporation |
| ferrite | masterbatch in siloxane | |
| Chromium | Chromium oxide green pigment as | Available from Ferro Corporation |
| oxide green | masterbatch in siloxane | |
| Titanium | Titanium dioxide | Available from Spectrum |
| dioxide | | |
| Hydrated | Hydromagnesite, Mg₅(CO₃)₄(OH)₂*4H₂O | Available from Fisher Scientific |
| magnesium | | |
| carbonate | | |
| mineral | | |
| Hydrous | Epsomite, MgSO₄*7H₂O | Available from Fisher Scientific |
| magnesium | | |
| sulfate mineral | | |
| Alumina | Al(OH)₃, 10 micrometer average particle | available under the name |
| trihydrate | size | HALTEX ™ 310 from TOR |
| | | Minerals International. |
| Magnesium | Mg(OH)₂, triethoxyvinylsilane treated, | Available under the name |
| Hydroxide | 0.7 micrometer average particle size. | ZEROGEN ™ 100 SP from Huber |
| | | Engineered Materials. |
| Magnesium | Needle-like silicate | Available under the name Adins |
| silicate | | Clay SIL-1 from Tolsa. |
| Calcium | Wollastonite powder | Available under the name M1250 |
| metalicate | | WOLLASTOCOAT ™ 10413 from |
| | | Imerys. |
| Silica 1 | Fumed silica | Available as CAB-O-SIL ™ MS |
| | | 75D from Cabot. |
| Silicone | A room temperature or heat curable two- | Available as DOWSIL ™ 3-8235 |
| Adhesive | part silicone foam adhesive. | Foam Part A and B from The Dow |
| | | Chemical Company. |
| Ceramic Sheet | Alumino-silicate ceramic fiber-based non- | Available from Mineral Seal |
| | woven fabric having a thickness of 3 mm. | Corporation as CeraTex ™ Ceramic |
| | | Fiber CeraTex ™ 3170. |

XIAMETER is a trademark of Dow Corning Corporation. DOWSIL is a trademark of the Dow
Chemical Company. HALTEX is a trademark of TOR Minerals International. ZEROGEN is a
trademark of J. M. Huber Corporation. WOLLASTOCOAT is a trademark of NYCO Minerals, Inc.
CAB-O-SIL is a trademark of Cabot Corporation. CeraTex is a trademark of Mineral Seal
Corporation.

Preparation of Additive A2. Prepare A2 as described in WO2020131985 using a standard mixing procedure as described in ASTM D3182. A2 consists of 7 wt % magnesium ferrite, 23 wt % ultramarine blue pigment, 23 wt % titanium dioxide, 6 wt % chromium oxide green and 41 wt % G1.
Preparation of Polysiloxane Layer. Prepare the polysiloxane layer as described in WO2020131985 using a standard mixing procedure as described in ASTM D3182. The polysiloxane layer consists of 17.19 wt % B1, 13.45 wt % G1, 33.52 wt % Alumina trihydrate, 20.12 wt % magnesium hydroxide, 0.8 wt % magnesium silicate, 8.05 wt % calcium metasilicate, 2.68 wt % A1, 1.07 wt % P1, 0.24 wt % F1, and 2.88 wt % A2. Prepare the polysiloxane layer to a thickness of 0.6 mm by calendaring the composition using a two-roll mill. Cure the sheets at 120 degrees Celsius (° C.) for 15 minutes in a hot press under 30 tons of pressure on a sample in a 30.5 centimeters wide by 30.5 centimeters long metal chase of 0.6 mm thickness to form a sample that has dimensions of 30.5 centimeters by 30.5 centimeters by 0.6 mm thick. The polysiloxane layer has a 10-percent modulus of 0.87 MegaPascals as determined according to ASTM D412.

### Characterization of Samples

Characterize samples using the following Thermal Insulating Property test and Flame

### Resistance Test:

Thermal Insulating Property Test. Place a hot plate in a hydraulic press enclosed in a space vented from one side of the hot plate with a venting port directly adjacent to the sample. Heat the hot-plate to 710° C. with a porous ceramic refractory insulator on the top surface of the hot-plate. Adhere four thermocouple probes onto an aluminum heat sink using Kapton tape. Place a Sample onto the aluminum heat sink and affix it to the aluminum heat sink using Kapton tape. Affix another thermocouple onto the sample surface using Kapton tape. Remove the insulator from the hot surface of the hot plate and rapidly place the Sample onto the hot surface of the hot plate with the aluminum heat sink on the opposite side of the sample from the hot plate. Quickly apply 355 kiloPascal pressure to compress the sample against the hot plate. Monitor the temperature of the hot plate surface and the sample using a data logger. When the temperature of the Sample side opposite the hot plate reaches 180° C. pressure is released and the test ended. The time required for the Sample side opposite the hot plate to reach 180° C. is noted as the Thermal Insulation Time in terms of seconds. Divide the Thermal Insulation Time by the thickness of the Sample to provide a “Time to 180° C. per millimeter thickness” in units of seconds per millimeter (s/mm). Longer times correspond to greater thermally insulating properties.

Flame Resistance Test. Observe the Sample during the Thermal Insulating Property Test to see if the Sample ignites. If flames are observed, note whether they are self-extinguishing within the testing time (time requires to reach 180° C.). General observations reveal that samples that ignite will generally do so within the first five seconds after coming into contact with the hot plate. If a Sample ignites during the testing time, it fails the Flame Resistance Test.

### Samples

Comparative Example (Comp Ex) A. Comp Ex A is a 10 centimeter (cm) by 10 cm square piece of the Ceramic Sheet. Characterization results: Sample Thickness: 3 mm Thermal Insulation Property test: 0.63 s/mm time to 180° C. per mm thickness. Flame Resistance Test: No flame.

Comp Ex B. Prepare Comp Ex B as a laminate using two 10 cm by 10 cm square pieces of Polysiloxane Layer and one 10 cm by 10 cm square piece of Ceramic Sheet. Apply 2 grams (g) of Silicone Adhesive onto both opposing primary surfaces of the ceramic sheet by dispensing Part A and Part B of the Silicone Adhesive through a static mixture to mix the parts together as they are dispensed. Apply the Silicone Adhesive onto the primary surfaces of the central layer around the voids as a bead approximately 3 millimeters in diameter. Adhere a Polysiloxane Layer sheet to each side of the Ceramic Sheet to form a preliminary laminate. Place the preliminary laminate into a chaise that is 25.4 cm by 25.4 cm by 4 mm and apply a 10 ton weight onto the laminated layers to press them together. Allow the compressed laminate layers to cure at 25° C. for 24 hours or to 60° C. for 10 minutes to achieve Comp Ex B. Comp Ex B has a final thickness of 4.5 mm. Characterization results: Sample Thickness: 4.5 mm. Thermal Insulation Property test: 18 s/mm time to 180° C. per mm thickness. Flame Resistance Test: No flame.

Example (Ex) 1. Prepare Ex 1 in like manner as Comp Ex B except define in the Ceramic Sheet 9 circular voids having diameters of 2.54 cm all the way through the thickness of the Ceramic Sheet and evenly distributed across the Ceramic Sheet. Distribute 3 grams of Hydrated magnesium carbonate mineral equally among the 9 voids to provide 44 vol % of endothermic agent in the ceramic sheet layer (the central layer of the laminate) prior to forming the laminate. Characterization results: Sample Thickness: 4.5 mm. Thermal Insulation Property test: 24 s/mm time to 180° C. per mm thickness. Flame Resistance Test: No flame.

Ex 2. Prepare Ex 2 in like manner as Comp Ex B except define centrally in the Ceramic Sheet one square void all the way through the thickness of the Ceramic Sheet and having dimension of 7.62 cm by 7.62 cm. Distribute 5 grams of Hydrated magnesium carbonate mineral in the void to provide 56 vol % of endothermic agent in the ceramic sheet layer (the central layer of the laminate) prior to forming the laminate. Characterization results: Sample Thickness: 4.5 mm. Thermal Insulation Property test: 45 s/mm time to 180° C. per mm thickness. Flame Resistance Test: No flame.

Ex 3. Prepare Ex 3 in like manner as Comp Ex B except define centrally in the Ceramic Sheet one square void all the way through the thickness of the Ceramic Sheet and having dimension of 7.62 cm by 7.62 cm. Distribute 22 grams of Hydrous magnesium sulfate mineral in the void to provide 56 vol % of endothermic agent in the ceramic sheet layer (the central layer of the laminate) prior to forming the laminate. Characterization results: Sample Thickness: 4.5 mm. Thermal Insulation Property test: 21 s/mm time to 180° C. per mm thickness. Flame Resistance Test: No flame.

Ex 4. Prepare Ex 4 in like manner as Comp Ex B except define in the Ceramic Sheet 9 circular voids having diameters of 2.54 cm all the way through the thickness of the Ceramic Sheet and evenly distributed across the Ceramic Sheet. Distribute 10 grams of Sodium bicarbonate equally among the 9 voids to provide 44 vol % of endothermic agent in the ceramic sheet layer (the central layer of the laminate) prior to forming the laminate.

Characterization results: Sample Thickness: 4.5 mm. Thermal Insulation Property test: 32 s/mm time to 180° C. per mm thickness. Flame Resistance Test: No flame.

The results indicate that inclusion of the endothermic agent into the central layer of the laminate structure results in greater thermal insulating properties as evidenced by a longer time to 180° C. per mm thickness relative to a similar laminate structure without endothermic agent or just the ceramic central layer alone.

1. An article comprising a multilayer laminate that comprises:
(a) a first surface layer with opposing primary surfaces, the first surface layer comprising a crosslinked polysiloxane matrix with flame retardant additive dispersed therein at a concentration in a range of 5-95 weight-percent based on first surface layer weight;
(b) a central layer with opposing primary surfaces with one primary surface adhered to a primary surface of the first surface layer and wherein the central layer is selected from ceramic fiber sheet and aerogel sheet;
(c) a second surface layer with opposing primary surface with one primary surface adhered to a primary surface of the central layer opposite the primary surface adhered to the first surface layer, the second surface layer having a composition as described for the first surface layer though the first and second surface layers do not have to have the same composition;
wherein the central layer defines one or more than one void such that the total volume of voids defined in the central layer is in a range of 5 to 95 volume-percent of volume defined by the central layer and wherein the article comprises endothermic agents that occupy the voids defined by the central layer.

2. The article of claim 1, wherein each of the first and second surface layers has a 10-percent strain modulus of at least 100 Pascals as determined according to ASTM D412.

3. The article of claim 1, wherein each of the first and second surface layers each has an average thickness in a range of 0.1 to 3.0 millimeters.

4. The article of claim 1, wherein the central layer has an average thickness in a range of 0.5 to 50 millimeters.

5. The article of claim 1, wherein the first and second surface layers each contain flame retardant at a concentration in a range of 50 to 85 weight-percent based on the weight of the layer it is in.

6. The article of claim 1, wherein the endothermic agent is present at a concentration in a range of 40 to 60 volume-percent of the volume defined by the central layer.

7. The article of any claim 1, wherein the endothermic agent is one or more than one selected from a group consisting of hydrated magnesium carbonate mineral, hydrous magnesium sulfate mineral, sodium bicarbonate, aluminum trihydrate, and magnesium hydroxide.

8. The article of claim 1, wherein the multilayer laminate further comprises an adhesive between the central layer and each of the first and second surface layers.

9. The article of claim 8, wherein the adhesive is a silicone adhesive.

10. The article of a claim 1, wherein the article further comprises battery cells that are electrically connected with one another with the multilayer laminate residing between the battery cells.
